(19) United States
(12) Patent Application Publication
(10) Pub. No.: US 2011/0020597 A1
(43) Pub. Date: Jan. 27, 2011

(54) HOT-MELT POLE, SECURING ASSEMBLY USING THE HOT-MELT POLE AND HOT-MELT METHOD USING SAME

(75) Inventors: LEI HUANG, Shenzhen City (CN); YONG-GANG ZENG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/607,316

(22) Filed: Oct. 28, 2009

(30) Foreign Application Priority Data
Jul. 24, 2009 (CN) 200910304839.3

(51) Int. Cl. B32B 3/10; B32B 37/06; B32B 37/04

(52) U.S. Cl. 428/131; 156/293

(57) ABSTRACT

A hot-melt pole is provided. The hot-melt pole comprises a first end and a second end opposite to the first end. The second end defines a guide hole. the guide hole is surrounded by a melting wall. A hot-melt method using the hot-melt pole is also provided.

### BACKGROUND

1. Technical Field

The present disclosure relates to a securing method, particularly, to a hot-melt pole and hot-melt method using the hot-melt pole.

2. Description of Related Art

The Hot-melt method is a common securing methods.

A typical hot-melt is used to combine two elements. One element includes a hot-melt pole. The other element defines a hot-melt hole. The hot-melt pole is inserted into the hot-melt hole, then melted and pressed by a device so as to link the two elements together.

However, the hot-melt pole is often deformed unevenly, such the two elements cannot stably combine with each other, deteriorating the lifespan of the two elements.

Therefore, there is room for improvement within the art.

### BRIEF DESCRIPTION OF THE DRAWINGS

Many aspects of the hot-melt pole and hot-melt method using same can be better understood with reference to the following drawings. These drawings are not necessarily drawn to scale, the emphasis instead being placed upon clearly illustrating the principles of the present hot-melt pole and hot-melt method using same. Moreover, in the drawings like reference numerals designate corresponding sections throughout the several views.

FIG. 1 is an exploded, isometric view of a cover assembly using the present hot-melt pole, in accordance with an exemplary embodiment.

FIG. 2 is an assembled, isometric view of the cover assembly shown in FIG. 1.

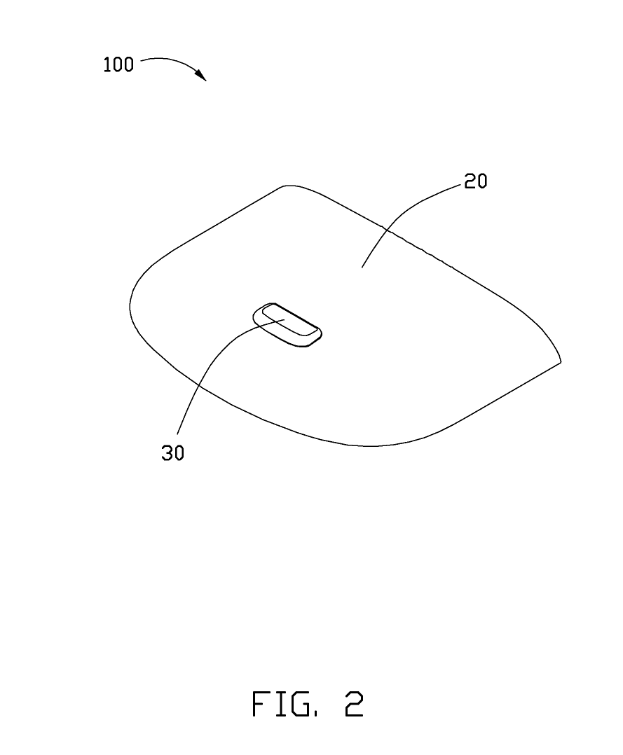

FIG. 3 is a schematic view showing the method of producing the cover assembly shown in FIG. 1.

FIG. 4 is similar to FIG. 2, but viewed from another aspect.

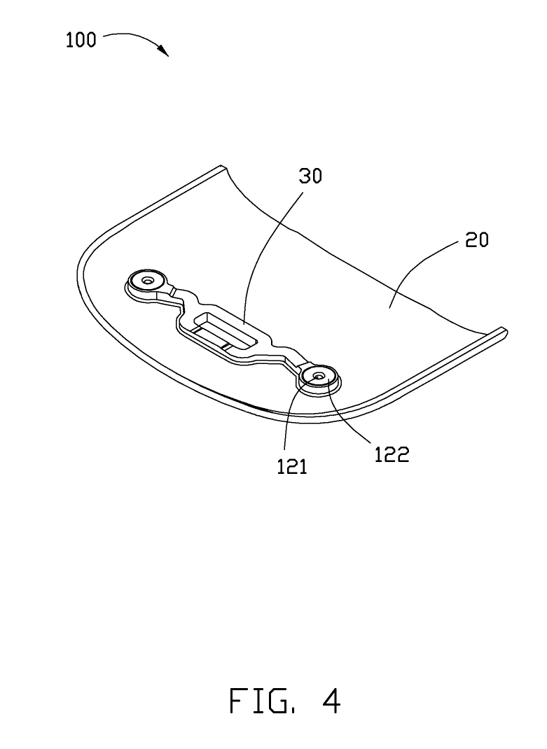

### DETAILED DESCRIPTION

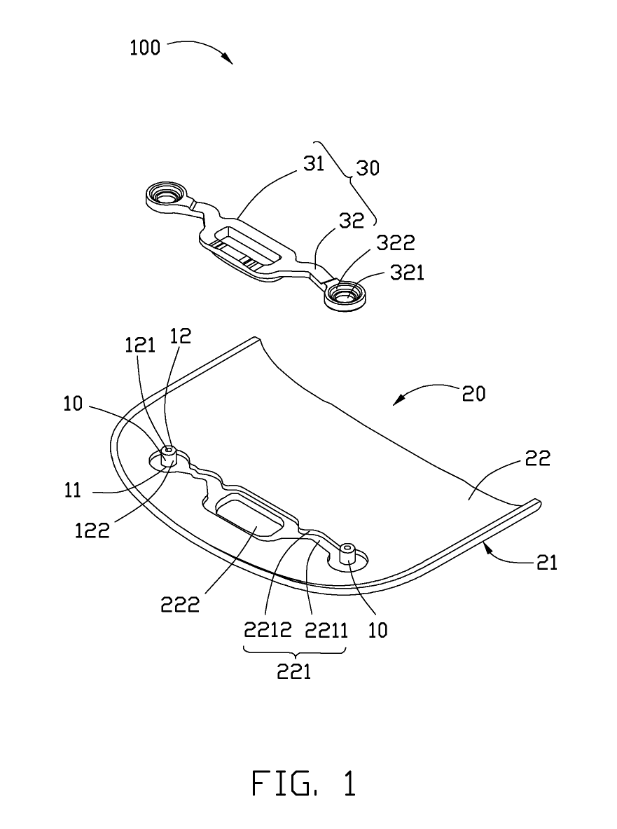

FIG. 1 shows a cover assembly 100 including an exemplary hot-melt pole 10. The cover assembly 100 includes two hot-melt poles 10, a cover member 20, and a button member 30. The present hot-melt pole is used to combine, in this embodiment, the cover member 20 and the button member 30 together.

The cover member 20 includes a first surface 21 and a second surface 22 opposite to the first surface 21. The second surface 22 is recessed to define a receiving groove 221. The receiving groove 221 has a similar shape and size as the button member 30, and configured for receiving the button member 30. The receiving groove 221 is surrounded by a bottom wall 2211 and a peripheral wall 2212. A hole 222 is defined through the bottom wall 2211 at a center thereof. One of the two hot-melt poles 10 protrudes from one end of the bottom wall 2211 on one side of the hole 222, the other hot-melt pole 10 protrudes from the other end of the bottom wall 2211 on the other side of hole 222.

The button member 30 includes a main portion 31 and two arms 32. The two arms 32 are secured to two opposite ends of the main portion 31, respectively. The main portion 31 is configured for being received in the hole 222, and being exposed from the first surface 21. Each arm 32 defines a hot-melt hole 321. The hot-melt hole 321 is a step hole, thus forming a ladder wall 322 surrounding the hot-melt hole 321. Each hot-melt hole 321 receives one corresponding hot-melt pole 10.

The hot-melt pole 10 is generally a hollow cylinder, and includes a first end 11 and an opposite second end 12. The first end 11 is secured to the cover member 20. The second end 12 defines a guide hole 121. The guide hole 121 is surrounded by a melting wall 122.

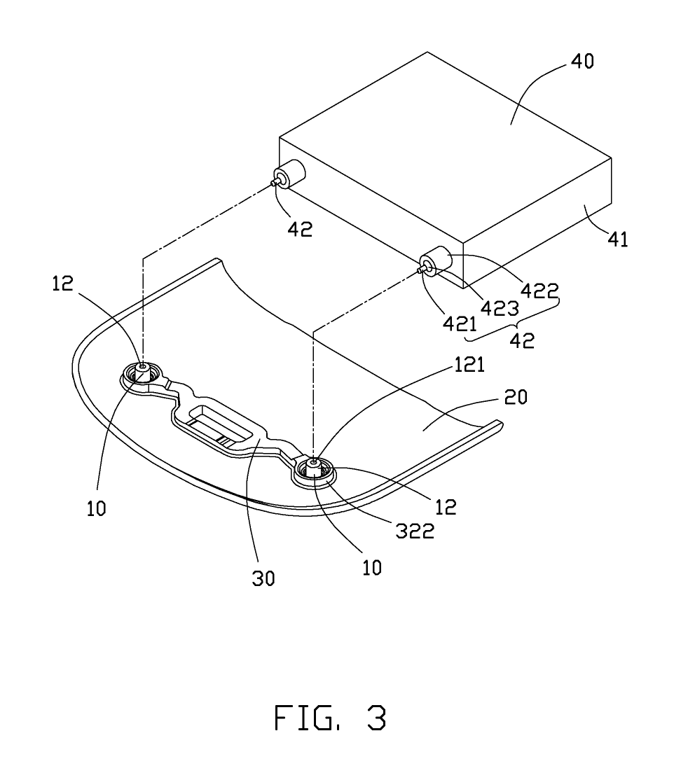

Referring to FIG. 3, to combine the button member 30 and the cover member 20, the button member 30 is inserted into the receiving groove 221, with the main portion 31 received in the hole 222. At this time, each hot-melt hole 321 receives one corresponding hot-melt pole 10. Then a hot-melt device 40 is provided. The hot-melt device 40 includes a body section 41 and two hot-melt heads 42 protruding from the body section 41. Each hot-melt head 42 includes a guide pin 421, a pressing portion 422 and a connecting portion 423. The connecting portion 423 connects the guide pin 421 and the pressing portion 422 together. The pressing portion 422 protrudes from one side of the body section 41. Each guide pin 421 is inserted into a corresponding guide hole 121 of one corresponding hot-melt pole 10. The pressing portion 422 heats up and presses the melting wall 122 of the hot-melt poles 10 to make the melting wall 122 melt and adhere to the ladder wall 322, thus connecting the button member 30 and the cover member 20 together.

The melting wall 122 of the present hot-melt pole 10 can be evenly melted and stably connect to the cover member 20, thus prolonging the lifespan of the two elements

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of sections within the principles of the disclosure to the full extent indicated by the broad general meaning of the terms, in which the appended claims are expressed.

What is claimed is:

1. A hot-melt pole comprising:
a first end; and
a second end opposite to the first end, the second end defining a guide hole, the guide hole being surrounded by a melting wall.

2. A securing assembly comprising:
a first member;
a second member;
at least one hot-melt pole, the hot-melt pole protruding from the second member, the hot-melt pole comprising a first end and a second end opposite to the first end, the second end defining a guide hole, the guide hole being surrounded by a melting wall; and
at least a hot-melt hole defined in the first member, the hot-melt hole configured for receiving the hot-melt pole.

3. The securing assembly as claimed in claim 2, wherein the first member is a cover member, the second member includes a buttonportion.

4. The securing assembly as claimed in claim 3, wherein the cover member includes a first surface and a second surface opposite to the first surface, the second surface is recessed to define a receiving groove configured for receiving the button member.

5. A hot-melt method to combine a first element and a second element comprising:
providing a hot-melt pole protruding from the first element, the hot-melt pole defining a guide hole surrounded by a melting wall;
defining a hot-melt hole in the second element;
inserting the hot-melt pole into the hot-melt hole;
using a hot-melt device, the hot-melt device comprising a hot-melt head, the hot-melt head including a guide pin, and a pressing portion;
inserting the guide pin into the guide hole;
heating up the pressing portion to melt the melting wall; and
pressing the melting wall until the melting wall adheres to the ladder wall.

6. The hot-melt method as claimed in claim 5, wherein the first element is a cover member, the second element includes a buttonportion.

7. The hot-melt method as claimed in claim 6, wherein the cover member includes a first surface and a second surface opposite to the first surface, the second surface is recessed to define a receiving groove configured for receiving the button member.

8. The hot-melt method as claimed in claim 7, wherein the receiving groove is surrounded by a bottom wall, the hot-melt pole protrudes from the bottom wall.

9. The hot-melt method as claimed in claim 7, wherein a hole is defined through the bottom wall, the button member includes a main portion, the main portion is received in the hole.

10. The hot-melt method as claimed in claim 5, wherein the hot-melt device further includes a body section, the hot-melt head protrudes from the body section.

11. The hot-melt method as claimed in claim 10, wherein the hot-melt head further includes a connecting portion, the connecting portion connects the guide pin and the pressing portion together.

12. The hot-melt method as claimed in claim 11, wherein the pressing portion protrudes from one side of the body section.
